(19) United States
(12) Patent Application Publication
(10) Pub. No.: US 2014/0366112 A1
(43) Pub. Date: Dec. 11, 2014

(54) SERVER APPARATUS, INFORMATION PROCESSING APPARATUS, IMAGING APPARATUS, SYSTEM, INFORMATION PROCESSING METHOD, AND PROGRAM

(71) Applicant: CANON KABUSHIKI KAISHA, Tokyo (JP)

(72) Inventor: Akihiro Hamana, Tokyo (JP)

(73) Assignee: CANON KABUSHIKI KAISHA, Tokyo (JP)

(21) Appl. No.: 14/293,504

(22) Filed: Jun. 2, 2014

(30) Foreign Application Priority Data
Jun. 7, 2013 (JP) 2013-120529

(51) Int. Cl. H04L 29/06

(52) U.S. Cl. CPC H04L 63/08
USPC 726/7

(57) ABSTRACT

A server apparatus includes: a first management unit which relates authentication image data of user authentication to authentication input data and manages the related data as authentication information; a request transmission unit which transmits a plurality of image data including the authentication image data included in the authentication information managed by the first management unit and transmits a request for the authentication input data related to the authentication image data; a reception unit which receives image data selected by a user from among the plurality of image data and input data input by the user in accordance with the request transmitted by the request transmission unit; and a determination unit which determines whether or not the user is successfully authenticated based on whether or not the authentication information in which the image data and the received input data are related to each other is managed by the first management unit.

### BACKGROUND OF THE INVENTION

1. Field of the Invention

The present invention relates to a server apparatus, an information processing apparatus, an imaging apparatus, a system, an information processing method, and a program.

2. Description of the Related Art

For example, in a related art as disclosed in Japanese Patent Application Laid-Open No. 2006-85560, an authentication apparatus on a network stores picked-up image data transmitted from an imaging apparatus, and the imaging apparatus also stores the picked-up image data. After that, the authentication apparatus compares the picked-up image data received from the imaging apparatus with the picked-up image data stored in the authentication apparatus itself, to thereby authenticate a user of the imaging apparatus.

With the related art, however, the user is required to hold the picked-up image data in the imaging apparatus at any time to authenticate the user himself/herself in the above-mentioned manner. The related art accordingly has a problem in that in a case where the user uses various types of imaging apparatus and electronic apparatus to make use of a service, the user is required to hold the picked-up image data for authentication in individual imaging apparatus and electronic apparatus. In other words, if a given user currently uses the electronic apparatus that does not hold the picked-up image data for authentication, the given user is not authenticated even in a case where the given user holds the picked-up image data for authentication in another apparatus, and hence the user cannot make use of the service. On the other hand, if the electronic apparatus holding the picked-up image data for authentication is lost or stolen, even an invalid user is authenticated, and hence a wrong usage of a service is undesirably possible, which is another problem of the related art.

### SUMMARY OF THE INVENTION

The present invention has an aspect to provide a technology for facilitating registration of authentication information for making use of a service on a network and input of the authentication information at a time of making use of the service, and enabling a user to make use of the service on various types of electronic apparatus.

According to an aspect of the invention, a server apparatus, comprises: a first management unit configured to relate authentication image data of user authentication to authentication input data and manage the related data as authentication information; a request transmission unit configured to transmit a plurality of image data including the authentication image data included in the authentication information managed by the first management unit and transmit a request for the authentication input data related to the authentication image data; a reception unit configured to receive a piece of image data selected by a user from among the plurality of image data and input data input by the user in accordance with the request transmitted by the request transmission unit; and a determination unit configured to determine whether or not the user is successfully authenticated based on whether or not the authentication information in which the image data and the input data that are received by the reception unit are related to each other is managed by the first management unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of a system configuration of a data management system.

FIG. 2 is a diagram illustrating an example of a hardware configuration of each of a server apparatus and a client apparatus.

FIG. 3 is a diagram illustrating an example of a hardware configuration of an imaging apparatus.

FIG. 4 is a back view illustrating an example of a configuration of the imaging apparatus.

FIG. 5 is a diagram illustrating an example of a password input screen.

FIG. 6 is a flow chart illustrating an example of processing of the imaging apparatus.

FIG. 7 is a flow chart illustrating an example of processing of the server apparatus.

FIG. 8 is a flow chart illustrating an example of processing of the imaging apparatus.

FIG. 9 is a flow chart illustrating an example of processing of the server apparatus.

FIGS. 10A, 10B, and 10C are diagrams each illustrating an example of a display screen of the client apparatus.

FIG. 11 is a flow chart illustrating an example of processing of the client apparatus.

FIG. 12 is a flow chart illustrating an example of processing of the server apparatus.

FIG. 13 is a flow chart illustrating an example of processing of the server apparatus.

FIG. 14 is a flow chart illustrating an example of processing of the server apparatus.

FIG. 15 is a diagram illustrating an example of a nickname input screen.

FIG. 16 is a flow chart illustrating an example of processing of the imaging apparatus.

FIG. 17 is a flow chart illustrating an example of processing of the server apparatus.

FIG. 18 is a diagram illustrating an example of a choice narrow-down condition setting screen.

FIG. 19 is a flow chart illustrating an example of processing of the client apparatus.

FIG. 20 is a flow chart illustrating an example of processing of the server apparatus.

### DESCRIPTION OF THE EMBODIMENTS

Various exemplary embodiments, features, and aspects of the present invention will be described in detail below with reference to the drawings.

### First Embodiment

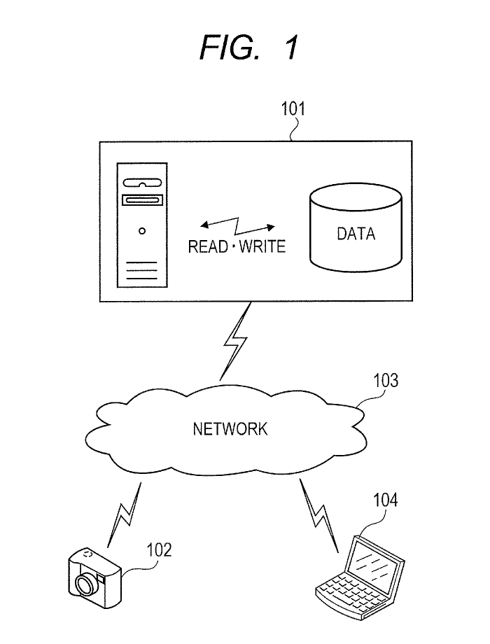

FIG. 1 is a diagram illustrating an example of a system configuration of a data management system.

As illustrated in FIG. 1, the data management system includes a server apparatus 101, an imaging apparatus 102, a network 103, and a client apparatus 104. The server apparatus 101, the imaging apparatus 102, and the client apparatus 104 can establish communication to/from one another via the network 103.

The imaging apparatus 102 has an imaging function of picking up an image and a character input function of enabling a user to enter a character string such as a password. Note that, the password is an example of authentication input data. The imaging apparatus 102 transmits to the server apparatus 101 image data to be used for authentication information (hereinafter referred to as “authentication image data”) picked up with the imaging function and data on the password to be used for the authentication information (hereinafter referred to simply as “password”) input with the character input function. Note that, data obtained by relating the authentication image data to the password is an example of the authentication information. The imaging apparatus 102 also transmits to the server apparatus 101 data of an identifier for identifying the own apparatus (hereinafter referred to as “imaging apparatus identifier”) held by the apparatus itself together with the authentication image data and the password. The imaging apparatus 102 further transmits to the server apparatus 101 picked-up image data not to be used for the authentication information (hereinafter referred to as “non-authentication image data”) together with the imaging apparatus identifier. Note that, the imaging apparatus identifier is an example of identification data.

The server apparatus 101 holds the authentication image data, password, and imaging apparatus identifier received from the imaging apparatus 102 in a storage device of the server apparatus 101 in relation to each other. Note that, data obtained by relating the authentication image data, the password, and the imaging apparatus identifier to each other is an example of first relation data. The server apparatus 101 further holds the non-authentication image data and imaging apparatus identifier received from the imaging apparatus 102 in the storage device of the server apparatus 101 in relation to each other. Note that, data obtained by relating the non-authentication image data and the imaging apparatus identifier to each other is an example of second relation data.

The client apparatus 104 has an image data display function of displaying the image data, an image data selection function of enabling the user to select the image data, and a character input function of enabling the user to enter a character string such as the password. In order to obtain the non-authentication image data from the server apparatus 101, the client apparatus 104 first notifies the server apparatus 101 of a request to obtain the non-authentication image data. When receiving the request to obtain the non-authentication image data from the client apparatus 104, the server apparatus 101 obtains the authentication image data usable for authentication from the storage device of the server apparatus 101, and transmits the obtained data to the client apparatus 104. The client apparatus 104 displays the authentication image data usable for authentication received from the server apparatus 101 with the image data display function. The client apparatus 104 further transmits to the server apparatus 101 authentication image data to be used as the authentication information, which is selected with the image data selection function from among a plurality of authentication image data usable for authentication, and the password to be used as the authentication information, which is entered with the character string input function. The server apparatus 101 determines whether or not a combination that matches a combination of the authentication image data and password received from the client apparatus 104 is held in the storage device of the server apparatus 101. Then, in a case where it is determined that the matching combination is found, the server apparatus 101 obtains the imaging apparatus identifier related to the combination of the authentication image data and the password from the storage device of the server apparatus 101. The server apparatus 101 further obtains the non-authentication image data related to the obtained imaging apparatus identifier from the storage device of the server apparatus 101, and transmits the obtained data to the client apparatus 104. The client apparatus 104 displays the non-authentication image data received from the server apparatus 101 with the image data display function.

Note that, the configuration of the data management system of FIG. 1 includes one imaging apparatus 102 and one client apparatus 104, but may include a plurality of imaging apparatuses 102 and a plurality of client apparatuses 104 and there is no limitation to the number of each of the imaging apparatus 102 and the client apparatus 104. In the case where the data management system includes a plurality of imaging apparatuses 102 and a plurality of client apparatuses 104, the server apparatus 101 can establish communication to/from the plurality of imaging apparatuses 102 and the plurality of client apparatuses 104, and performs processing similar to the one described above on the multiple imaging apparatus 102 and the multiple client apparatus 104.

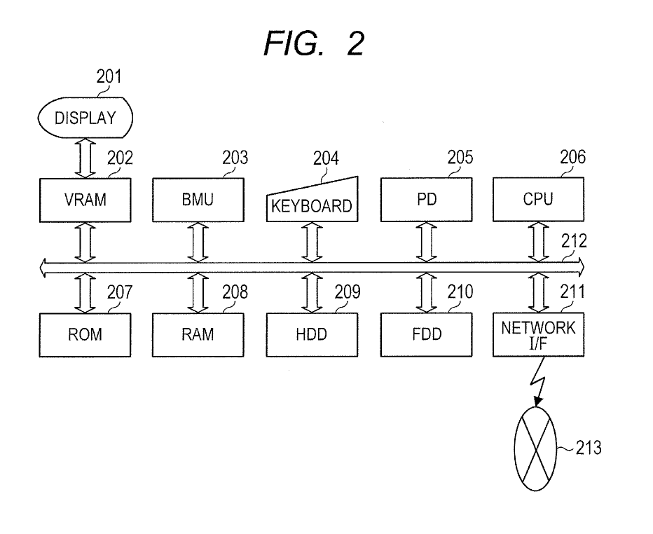

FIG. 2 is a diagram illustrating an example of a hardware configuration of each of the server apparatus 101 and the client apparatus 104.

A CPU 206 of the server apparatus 101 executes a control program stored in a ROM 207, an HDD 209, or the like, to thereby realize functions of the server apparatus 101 and processing of flow charts relating to the server apparatus 101, which are described later.

In addition, the CPU 206 of the client apparatus 104 executes a control program stored in the ROM 207, the HDD 209, or the like, to thereby realize functions of the client apparatus 104 and processing of flow charts relating to the client apparatus 104, which are described later.

The following description is directed to a case where FIG. 2 illustrates the hardware configuration of the server apparatus 101, but the same holds true for a case where FIG. 2 illustrates the hardware configuration of the client apparatus 104.

The server apparatus 101 includes a display 201, a VRAM 202, a bit move unit (BMU) 203, and a keyboard 204. The server apparatus 101 further includes a pointing device (PD) 205, the CPU 206, the ROM 207, a RAM 208, the HDD 209, an FDD 210, and a network I/F 211.

Displayed on the display 201 are, for example, data held by the server apparatus 101, data supplied thereto, other types of editing information, an icon, a message, a menu, and other types of user interface information.

The VRAM 202 is a memory for drawing image data to be displayed on the display 201 by the CPU 206 and storing the drawn image data thereinto. The CPU 206 transfers the image data generated on the VRAM 202 to the display 201 in accordance with a predetermined protocol and displays the image data on the display 201.

The BMU 203 controls, for example, data transfer between memories (such as the VRAM 202 and other memories) and data transfer between one of the memories and each I/O device (such as the network I/F 211).

The keyboard 204 includes various types of keys to be used by the user to input a document and the like.

The PD 205 is used to, for example, operate the icon, menu, and other contents displayed on the display 201 and drag-and-drop an object.

The CPU 206 executes the control program stored in the ROM 207, the HDD 209, or a flexible disk, to thereby control respective devices.

The ROM 207 holds various types of control programs and data. The ROM 207 of the server apparatus 101 also stores a program for realizing processing of obtaining meta data included in the image data, such as a type of the apparatus and a photographing date and time.

The RAM 208 functions as, for example, a work area of the CPU 206, a data evacuation area to be used at a time of error processing, and a load area for the control program.

The HDD 209 stores, for example, respective control programs to be executed by the CPU 206, contents, and data. The CPU 206 of the server apparatus 101 relates the authentication image data, the password, and the imaging apparatus identifier to each other and manages the related data on the HDD 209. The CPU 206 of the server apparatus 101 also relates the non-authentication image data and the imaging apparatus identifier to each other and manages the related data on the HDD 209.

The FDD 210 controls an access to the flexible disk.

The network I/F 211 is an interface for connecting to a network line 213 such as the Internet.

A CPU bus 212 includes an address bus, a data bus, and a control bus.

The control program may be provided to the CPU 206 from the ROM 207, the HDD 209, or the FDD 210, or from another information processing apparatus or the like via the network I/F 211 and the network.

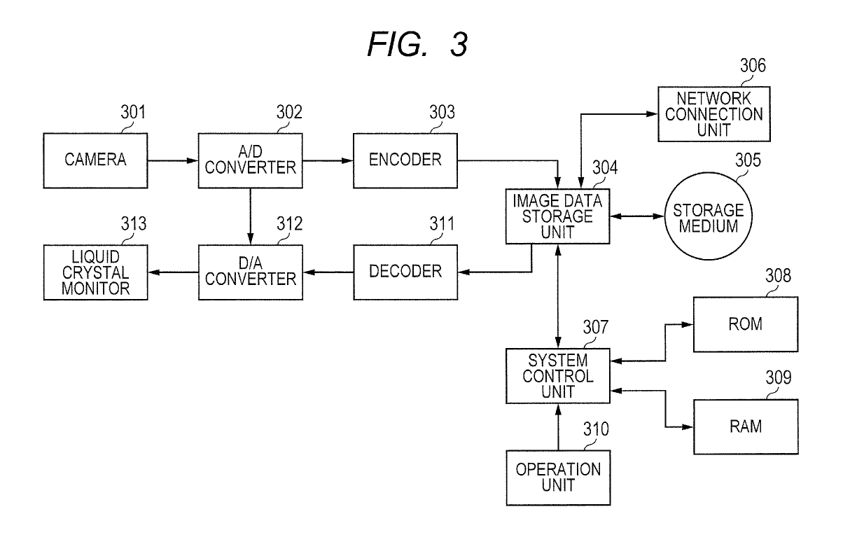

FIG. 3 is a diagram illustrating an example of a hardware configuration of the imaging apparatus 102.

A camera 301 converts an optical image of a subject into an electrical signal.

An A/D converter 302 converts an analog signal input thereto into a digital signal.

An encoder 303 performs compression encoding on digital image data to convert the digital image data into, for example, a JPEG format.

An image data storage unit 304 generates a file of the image data (image file) and stores the generated file in a storage medium 305.

The storage medium 305 is a randomly-accessible storage medium, and stores digital data such as the image data as a file.

A network connection unit 306 is connected to the server apparatus 101 to transmit the digital data such as the image data.

A system control unit 307 includes a microcomputer, and controls an overall operation of its own imaging apparatus 102. Note that, a CPU included in the microcomputer of the system control unit 307 executes a control program stored in a ROM 308 or the like, to thereby realize functions of the system control unit. In this manner, the system control unit 307 realizes the functions of the imaging apparatus 102 and the processing of the flow charts relating to the imaging apparatus 102, which are described later.

The ROM 308 holds the control program and various types of data. The ROM 308 also holds server information including address information for accessing the server apparatus 101.

A RAM 309 functions as, for example, a load area for the control program executed by the CPU included in the system control unit 307. The RAM 309 further temporarily holds the authentication image data and password to be registered in the server apparatus 101 as the authentication information.

An operation unit 310 includes an operation panel, a remote controller, and others, and inputs various types of data and commands based on the user's operation.

A decoder 311 decodes the compression-encoded digital data.

A D/A converter 312 converts the digital signal into the analog signal.

A liquid crystal monitor 313 is a display unit.

Various types of control programs required for the CPU included in the system control unit 307 to realize various types of functions of the imaging apparatus 102 are assumed to be stored in the ROM 308, but there is no need to limit the invention to this configuration. For example, those control programs may be stored in the storage medium 305 such as a memory card, or in a storage area on the network accessible from the imaging apparatus 102.

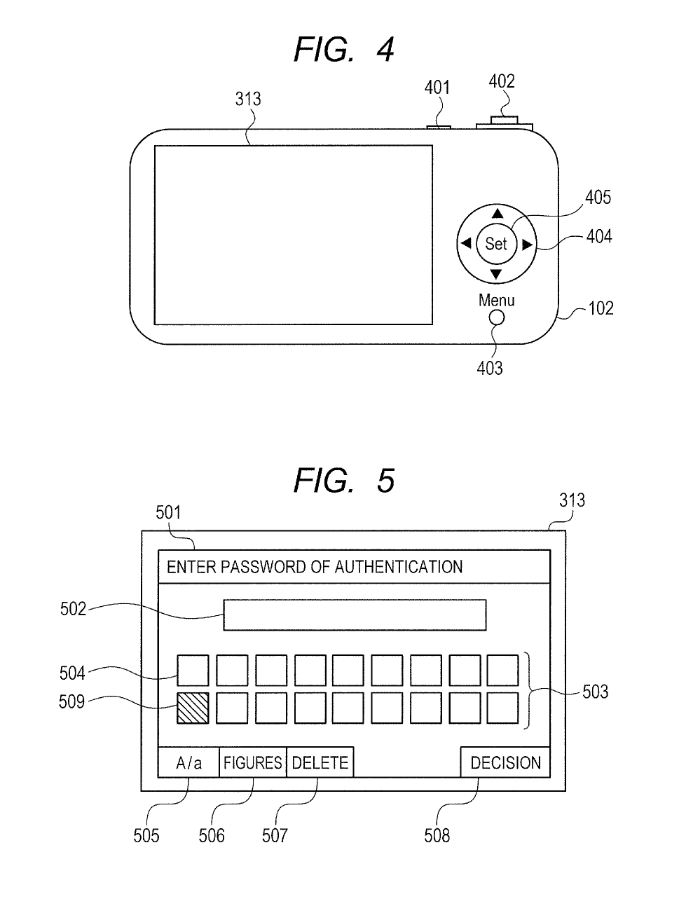

FIG. 4 is a back view illustrating an example of a configuration of the imaging apparatus 102.

The imaging apparatus 102 includes a power switch button 401, a shutter release button 402, the liquid crystal monitor 313, a menu button 403, a cursor button 404, and a set button 405.

The power switch button 401 is a button for turning ON or OFF the power of the imaging apparatus 102.

The shutter release button 402 is a button for picking up the image data.

The liquid crystal monitor 313 is a viewfinder to be used by the user to confirm a picked-up image. The liquid crystal monitor 313 is also a display area for displaying, for example, an operation menu and alphabets and figures for entering characters such as the password.

The menu button 403 is a button for displaying the operation menu on the liquid crystal monitor 313.

The cursor button 404 is used to give an instruction to move in an upward, downward, leftward, or rightward direction, and is used to change a selection state of the operation menu displayed on the liquid crystal monitor 313 and switch the operation menu. The cursor button 404 is also used to change a selection state of each of the characters when the characters such as the password are entered.

The set button 405 is used to select the operation menu displayed on the liquid crystal monitor 313 and determine the characters when the characters such as the password are entered.

The imaging apparatus 102 displays various types of operation screens on the liquid crystal monitor 313 of the imaging apparatus 102 when the authentication information is to be registered in the server apparatus 101. The user inputs data and makes settings in accordance with the operation screens displayed on the liquid crystal monitor 313.

When the user depresses the menu button 403, the imaging apparatus 102 displays a menu screen on the liquid crystal monitor 313. The menu screen includes a plurality of screens, which are provided for respective types of items, and the user can switch the screens from one screen to another with use of tabs for screen switching. The user operates the cursor button 404 in a leftward or rightward direction to switch the tabs for screen switching from one tab to another. Further, respective menu items are displayed in the menu screen, and the user can move a cursor indicating that a corresponding item is currently selected by operating the cursor button 404 in an upward or downward direction. Moreover, when the user depresses the set button 405, an item that is indicated by the cursor is selected from among the items displayed in the menu screens, which are provided for respective types of items. Assumed is, for example, a case where the menu screen has a menu item “Set Authentication Information” for registering the authentication information and the user depresses the set button 405 under a state in which this menu item is currently selected. In this case, the imaging apparatus 102 switches its mode to an imaging mode for picking up an authentication image, and displays a screen associated with this imaging mode. Note that, the operation screen displayed in the imaging mode for the authentication image is an example of a first operation screen. Further, when the user depresses the menu button 403, the imaging apparatus 102 stops displaying the menu screen. Further, when the user depresses the shutter release button 402 in the imaging mode with the menu item “Set Authentication Information” selected, the imaging apparatus 102 displays a password input screen of FIG. 5 to be described below.

FIG. 5 is a diagram illustrating an example of the password input screen.

In the password input screen 501 displayed on the liquid crystal monitor 313, a message for prompting the user to enter the password to be used for authentication is displayed.

A password entry field 502 is an entry field for displaying characters that are entered as the password.

Displayed in a character button display area 503 are character buttons 504 for alphabets and figures to be used at the time of entering the password.

An alphabet display switch button 505 is a button for switching, in a case where the character buttons 504 for alphabets are displayed in the character button display area 503, cases of the alphabets of the character buttons 504 to be displayed in the character button display area 503 between the lower-case alphabets and the upper-case alphabets. In addition, the alphabet display switch button 505 is a button for switching, in a case where the character buttons 504 for figures are displayed in the character button display area 503, the character buttons to be displayed in the character button display area 503 to the buttons for alphabets.

A figure display switch button 506 is a button for switching, in a case where the character buttons 504 for alphabets are displayed in the character button display area 503, the character buttons to be displayed in the character button display area 503 to the buttons for figures.

An input character deletion button 507 is a button for deleting the last character of the password currently entered. In a case where the user selects the input character deletion button 507 to delete the last character of the password currently entered, the last character of the characters displayed in the password entry field 502 is no longer displayed.

A password decision button 508 is a button for deciding the characters displayed in the password entry field 502 as the password.

The user operates the character buttons 504, the alphabet display switch button 505, the figure display switch button 506, the input character deletion button 507, and the password decision button 508 with use of the cursor button 404 and the set button 405. To be more specific, the user operates the cursor button 404 in the upward or downward direction to move a cursor 509 indicating that a corresponding item is currently selected, and then depresses the set button 405. Note that, the screen configuration may be such that, when there is no character displayed in the password entry field 502, the password decision button 508 is grayed out so that even when the user operates the cursor button 404, the user cannot select the password decision button 508.

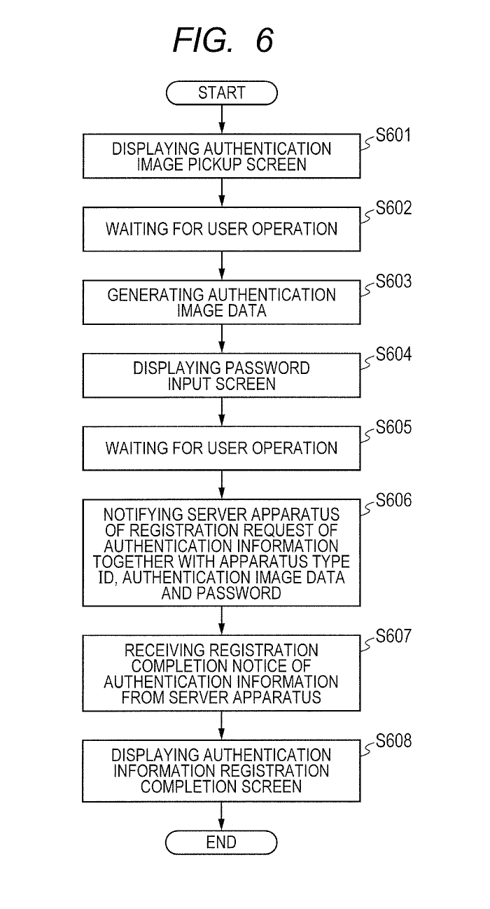

FIG. 6 is a flow chart illustrating an example of processing of the imaging apparatus 102 executed when the user selects the menu “Set Authentication Information” on the imaging apparatus 102. In Step S601, the system control unit 307 shifts its mode to the imaging mode, and displays an image that is currently picked up on the liquid crystal monitor 313.

In Step S602, the system control unit 307 now waits for the user to pick up the authentication image, and waits for depression of the shutter release button 402.

In Step S603, in a case where the shutter release button 402 is depressed, the system control unit 307 picks up the image of the subject with use of the camera 301, and after the processing of the A/D converter 302 and the encoder 303 on the picked-up image, the image data storage unit 304 generates the authentication image data.

In Step S604, the system control unit 307 displays the password input screen 501 on the liquid crystal monitor 313.

In Step S605, the system control unit 307 now waits for the user to enter the password, and waits for an entry of the password.

In Step S606, the system control unit 307 transmits an apparatus type ID as the imaging apparatus identifier, the authentication image data generated in Step S603, and the password entered in Step S605 to the server apparatus 101 via the network connection unit 306, to thereby notify the server apparatus 101 of a request to register the authentication information. Note that, the apparatus type ID as the imaging apparatus identifier is held in advance in the ROM 308 of the imaging apparatus 102. The processing of Step S606 is an example of first transmission processing.

In Step S607, the system control unit 307 receives a registration completion notice of the authentication information from the server apparatus 101 via the network connection unit 306.

In Step S608, the system control unit 307 displays an authentication information registration completion screen on the liquid crystal monitor 313.

The processing described above enables the imaging apparatus 102 to easily register the authentication information in the server apparatus 101. In addition, the imaging apparatus 102 sets the combination of the authentication image data and the password as the authentication information, and the imaging apparatus 102 can thus ensure security against a wrong usage of a service.

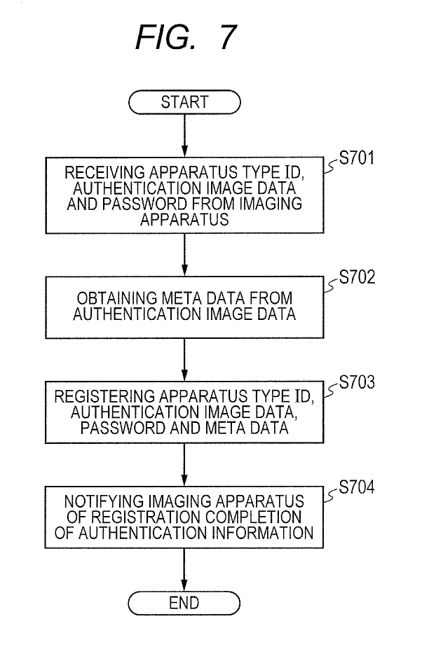

FIG. 7 is a flow chart illustrating an example of processing executed when the server apparatus 101 receives the request to register the authentication information from the imaging apparatus 102.

In Step S701, the CPU 206 of the server apparatus 101 receives the apparatus type ID, the authentication image data, and the password from the imaging apparatus 102 via the network I/F 211.

In Step S702, the CPU 206 of the server apparatus 101 obtains the meta data, such as the type of the apparatus and the photographing date and time, included in the authentication image data received in Step S701.

In Step S703, the CPU 206 of the server apparatus 101 holds the apparatus type ID, authentication image data, and password received in Step S701 and the meta data obtained in Step S702 in the HDD 209 of the server apparatus 101 to register those pieces of information and data.

In Step S704, the CPU 206 of the server apparatus 101 transmits the registration completion notice of the authentication information to the imaging apparatus 102 via the network I/F 211.

The processing described above enables the server apparatus 101 to easily register the authentication information.

Note that, when the imaging apparatus 102 registers the non-authentication image data in the server apparatus 101, various types of operation screens are displayed on the liquid crystal monitor 313 of the imaging apparatus 102. The user inputs data and makes settings in accordance with the displayed operation screens. To be more specific, the imaging apparatus 102 displays a menu screen for selecting whether or not to save the picked-up image data displayed on the liquid crystal monitor 313 in the server apparatus 101. Then, when the user operates the imaging apparatus 102 so that a menu item “Online Imaging” is currently selected, and depresses the set button 405, the imaging apparatus 102 switches its mode to an imaging mode for picking up the non-authentication image data, and displays a screen associated with this imaging mode. Note that, the operation screen displayed in the imaging mode for the non-authentication image data is an example of a second operation screen. If the user depresses the shutter release button 402 in a normal imaging mode, the imaging apparatus 102 picks up the non-authentication image data. If the user operates the set button 405 and selects a transmission button to give a transmission instruction, the imaging apparatus 102 displays the picked-up non-authentication image data and transmits this data to the server apparatus 101.

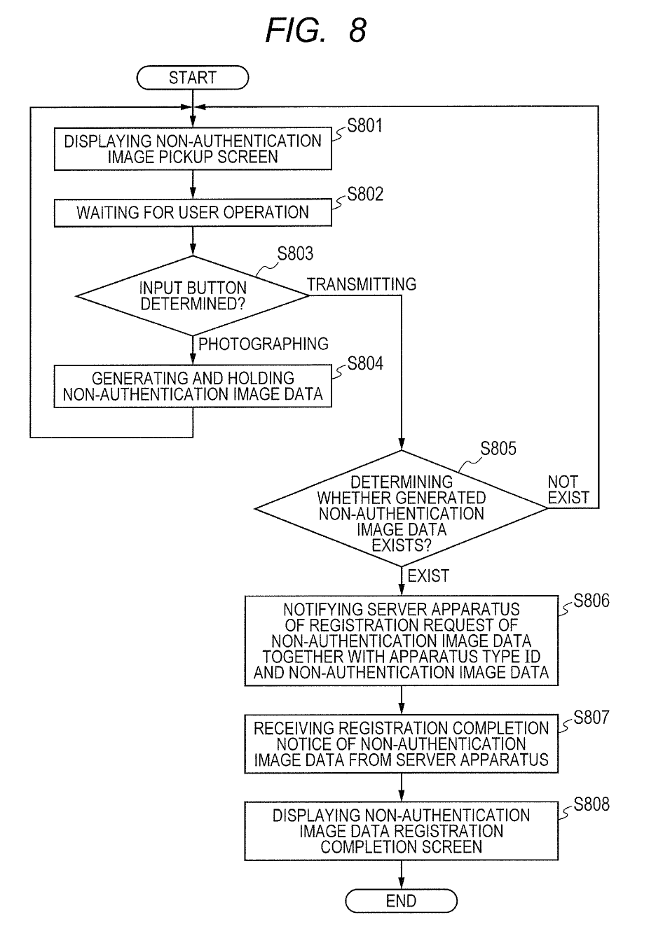

FIG. 8 is a flow chart illustrating an example of processing executed when the imaging apparatus 102 registers the non-authentication image data in the server apparatus 101.

In Step S801, the system control unit 307 displays a non-authentication image pickup screen on the liquid crystal monitor 313.

In Step S802, the system control unit 307 now waits for an input of the user, and waits for any one of inputs including depression of the shutter release button 402 and selection of the transmission button for transmitting the non-authentication image data.

In Step S803, the system control unit 307 determines a button depressed by the user in Step S802. In a case where it is determined that the shutter release button 402 is depressed, the system control unit 307 proceeds the processing to Step S804. On the other hand, in a case where it is determined that the transmission button is selected, the system control unit 307 proceeds the processing to Step S805.

In Step S804, the system control unit 307 picks up the image of the subject with use of the camera 301, and after the processing of the A/D converter 302 and the encoder 303 on the picked-up image, the image data storage unit 304 generates the non-authentication image data.

In Step S805, the system control unit 307 determines whether or not there exists non-authentication image data that is generated after the non-authentication image pickup screen is displayed in Step S801. If it is determined that the generated non-authentication image data exists, the system control unit 307 proceeds the processing to Step S806. On the other hand, if it is determined that the generated non-authentication image data does not exist, the system control unit 307 returns the processing to Step S801.

In Step S806, the system control unit 307 transmits an apparatus type ID as the imaging apparatus identifier and the non-authentication image data generated in Step S804 to the server apparatus 101 via the network connection unit 306, to thereby notify the server apparatus 101 of a request to register the non-authentication image data. Note that, the apparatus type ID as the imaging apparatus identifier is held in advance in the ROM 308 of the imaging apparatus 102. The processing of Step S806 is an example of second transmission processing.

In Step S807, the system control unit 307 receives a registration completion notice of the non-authentication image data from the server apparatus 101 via the network connection unit 306.

In Step S808, the system control unit 307 displays a non-authentication image data registration completion screen on the liquid crystal monitor 313.

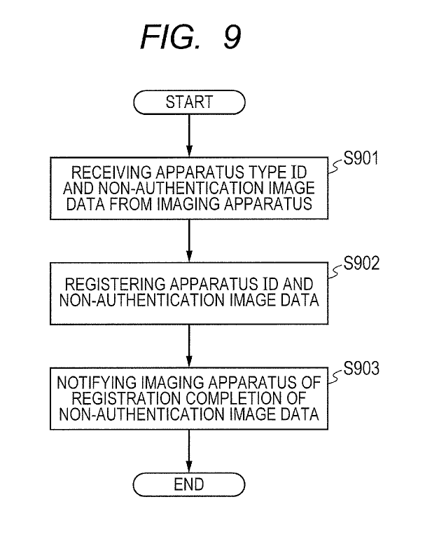

FIG. 9 is a flow chart illustrating an example of processing executed when the server apparatus 101 receives the request to register the non-authentication image data from the imaging apparatus 102.

In Step S901, the CPU 206 of the server apparatus 101 receives the apparatus type ID and the non-authentication image data from the imaging apparatus 102 via the network I/F 211.

In Step S902, the CPU 206 of the server apparatus 101 holds the apparatus type ID and non-authentication image data received in Step S901 in the HDD 209 of the server apparatus 101 to register the piece of information and data.

In Step S903, the CPU 206 of the server apparatus 101 transmits the registration completion notice of the non-authentication image data to the imaging apparatus 102 via the network I/F 211.

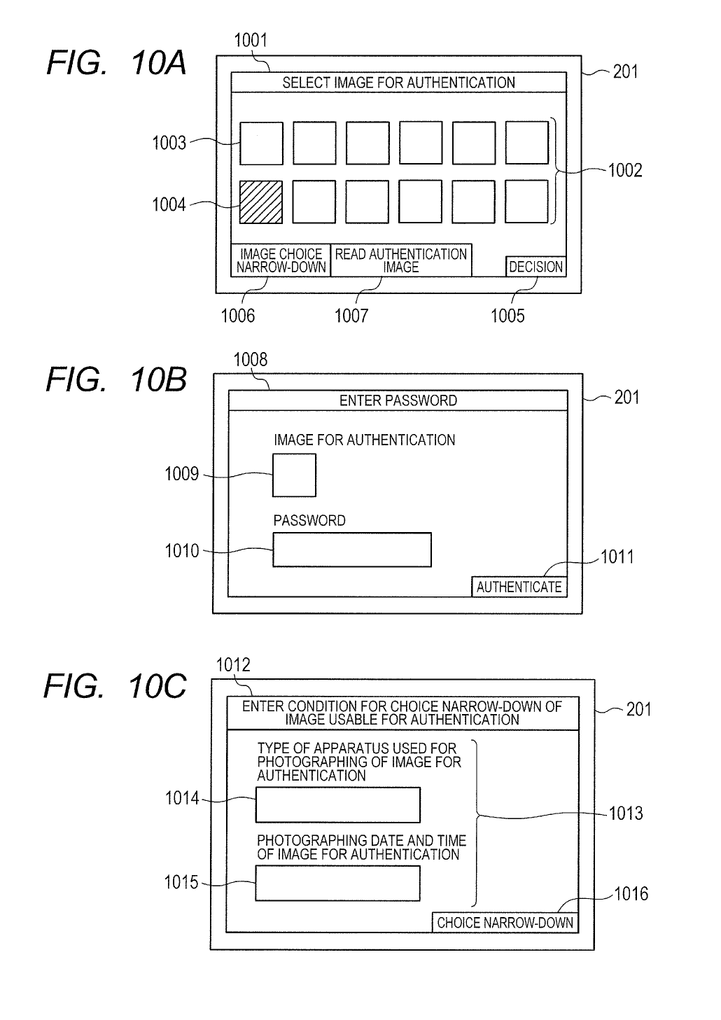

FIGS. 10A to 10C are diagrams each illustrating an example of the operation screen displayed on the display 201 of the client apparatus 104 in order to execute authentication processing in a case where the client apparatus 104 obtains the non-authentication image data from the server apparatus 101.

FIG. 10A is a diagram illustrating an example of the authentication image data selection screen.

In FIG. 10A, an authentication image data selection screen 1001 is displayed on the display 201. The client apparatus 104 displays the authentication image data selection screen 1001 on the display 201 when sending to the server apparatus 101 via the network I/F 211 a request to obtain the non-authentication image data or a choice narrow-down request to choose and narrow down the authentication image data to be described later.

Displayed in the authentication image data selection screen 1001 is a message for prompting the user to select the image to be used for authentication.

Displayed in an authentication image data display area 1002 is a list of authentication image data 1003 that are usable for authentication and received from the server apparatus 101. Further, the user can operate the PD 205 to move a cursor 1004 which indicates that a corresponding item is currently selected, so that another authentication image data 1003 is in a currently-selected state.

A decision button 1005 is a button for selecting the authentication image data 1003 which is in a currently-selected state. If the user operates the PD 205 and depresses the decision button 1005, the client apparatus 104 displays a password input screen of FIG. 10B to be described later.

An authentication image data choice narrow-down button 1006 is a button for choosing and narrowing down authentication image data 1003 to be displayed in the authentication image data selection screen 1001. If the user operates the PD 205 to depress the authentication image data choice narrow-down button 1006, the client apparatus 104 displays a choice narrow-down condition setting screen of FIG. 10C.

An authentication image data read button 1007 is a button for reading the authentication image data to be used for authentication from the HDD 209. If the user operates the PD 205 to depress the authentication image data read button 1007, the client apparatus 104 reads the authentication image data to be used for authentication from the HDD 209, and displays the password input screen of FIG. 10B to be described later.

FIG. 10B is a diagram illustrating an example of the password input screen.

In FIG. 10B, a password input screen 1008 is displayed on the display 201.

Displayed in the password input screen 1008 are a message for prompting the user to enter the password to be used for authentication and authentication image data 1009 selected by the operation in the authentication image data selection screen 1001 or read from the HDD 209.

A password entry field 1010 is an entry field for displaying the characters entered as the password.

An authentication button 1011 is a button for determining the characters displayed in the password entry field 1010 as the password and sending an authentication request to the server apparatus 101. If the user operates the PD 205 to depress the authentication button 1011, the client apparatus 104 transmits the authentication image data 1009 and the determined password to the server apparatus 101. Note that, the screen configuration may be such that, in a case where there is no character displayed in the password entry field 1010, the authentication button 1011 is grayed out so that even if the user operates the PD 205, the user cannot depress the authentication button 1011.

FIG. 10C is a diagram illustrating an example of the choice narrow-down condition setting screen.

In FIG. 10C, a choice narrow-down condition setting screen 1012 is displayed on the display 201.

Displayed in the choice narrow-down condition setting screen 1012 is a message for prompting the user to enter conditions for choice narrow-down of the authentication image data 1003 to be displayed in the authentication image data selection screen 1001.

Displayed in a choice narrow-down condition display area 1013 are an apparatus type entry field 1014 for entering the type of the apparatus that picks up the authentication image data, which is usable as a condition for choosing and narrowing down the authentication image data 1003, and a photographing date and time entry field 1015 for entering the photographing date and time, which is also usable as a condition for choosing and narrowing down the authentication image data 1003.

The apparatus type entry field 1014 is an entry field for displaying the characters entered as the type of the apparatus that picks up the authentication image data.

The photographing date and time entry field 1015 is an entry field for displaying the characters entered as the photographing date and time at which the authentication image data is picked up.

A choice narrow-down button 1016 is a button for determining the characters displayed in the apparatus type entry field 1014 and the photographing date and time entry field 1015 as choice narrow-down conditions and sending to the server apparatus 101 the choice narrow-down request to choose and narrow down the authentication image data usable for authentication. If the user operates the PD 205 to depress the choice narrow-down button 1016, the client apparatus 104 transmits the determined choice narrow-down conditions to the server apparatus 101. This configuration enables the user of the client apparatus 104 to easily select desired authentication image data even in a case where there are a large number of authentication image data, thus enhancing the convenience. Note that, it is not always necessary that the choice narrow-down conditions include both the type of the apparatus and the photographing date and time, and the choice narrow-down conditions may include only one of those conditions. In addition, the screen configuration may be such that, in a case where there is no character displayed in any of the apparatus type entry field 1014 and the photographing date and time entry field 1015, the choice narrow-down button 1016 is grayed out so that even if the user operates the PD 205, the user cannot depress the choice narrow-down button 1016.

In the manner described above, the client apparatus 104 notifies the server apparatus 101 of the authentication request via the network I/F 211. In a case where authentication processing is successful, the server apparatus 101 transmits to the authenticated user a list of non-authentication image data that the user is allowed to view and download. The client apparatus 104 displays a success notification that is an authentication result received from the server apparatus and the list of non-authentication image data on the display 201.

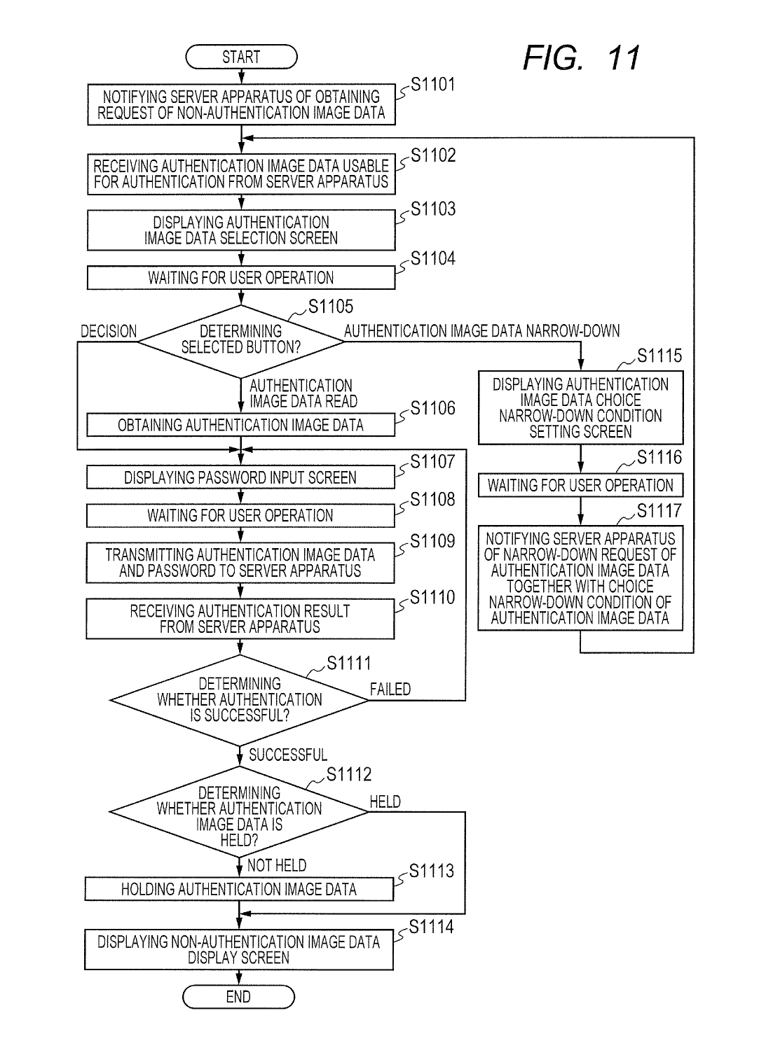

FIG. 11 is a flow chart illustrating an example of processing executed in a case where the client apparatus 104 obtains the non-authentication image data from the server apparatus 101.

In Step S1101, the CPU 206 of the client apparatus 104 notifies the server apparatus 101 of a request to obtain the non-authentication image data via the network I/F 211. Note that, the processing of Step S1101 is an example of obtaining request transmission processing.

In Step S1102, the CPU 206 of the client apparatus 104 receives a plurality of image data including the authentication image data usable for authentication from the server apparatus 101 via the network I/F 211. This processing is an example of request reception processing in which the CPU 206 of the client apparatus 104 receives, together with the received authentication image data, a request for the password associated with the authentication image data.

In Step S1103, the CPU 206 of the client apparatus 104 displays the authentication image data selection screen 1001 on the display 201.

In Step S1104, the CPU 206 of the client apparatus 104 now waits for the user's input, and waits until any one of the decision button 1005, the authentication image data choice narrow-down button 1006, and the authentication image data read button 1007 is selected.

In Step S1105, the CPU 206 of the client apparatus 104 determines the selected button, and when determining that the decision button 1005 is selected, the CPU 206 proceeds the processing to Step S1107. When determining that the authentication image data choice narrow-down button 1006 is selected, the CPU 206 of the client apparatus 104 proceeds the processing to Step S1115, and when determining that the authentication image data read button 1007 is selected, the CPU 206 proceeds the processing to Step S1106.

In Step S1106, the CPU 206 of the client apparatus 104 obtains from the HDD 209 the image data determined by the user's operation as the authentication image data.

In Step S1107, the CPU 206 of the client apparatus 104 displays the password input screen 1008 on the display 201.

In Step S1108, the CPU 206 of the client apparatus 104 is now in a routine for waiting for the user to enter the password, and then waits for an entry of the password.

In Step S1109, the CPU 206 of the client apparatus 104 transmits to the server apparatus 101 via the network I/F 211 the image data determined as the authentication image data and the password entered by the user in Step S1108, to thereby notify the server apparatus 101 of the authentication request. To be more specific, the CPU 206 of the client apparatus 104 transmits as the authentication image data the image data selected by the user in Step S1104 or obtained from the HDD 209 in Step S1106.

In Step S1110, the CPU 206 of the client apparatus 104 receives the authentication result from the server apparatus 101 via the network I/F 211. Note that, in a case where the authentication result is successful, the CPU 206 of the client apparatus 104 receives the non-authentication image data together with the authentication result.

In Step S1111, the CPU 206 of the client apparatus 104 determines whether or not the authentication result received in Step S1110 is successful. If the authentication result is successful, the CPU 206 proceeds the processing to Step S1112, and if the authentication result is failed, the CPU 206 returns the processing to Step S1107.

In Step S1112, the CPU 206 of the client apparatus 104 determines whether or not the authentication image data transmitted to the server apparatus 101 in Step S1109 is held in the HDD 209, and when determining that the authentication image data is held, the CPU 206 proceeds the processing to Step S1114. On the other hand, when determining that the authentication image data is not held, the CPU 206 of the client apparatus 104 proceeds the processing to Step S1113.

In Step S1113, the CPU 206 of the client apparatus 104 holds in the HDD 209 the authentication image data transmitted to the server apparatus 101 in Step S1109.

In Step S1114, the CPU 206 of the client apparatus 104 displays a non-authentication image data display screen on the display 201.

In Step S1115, the CPU 206 of the client apparatus 104 displays the authentication choice narrow-down condition setting screen 1012 on the display 201.

In Step S1116, the CPU 206 of the client apparatus 104 is now in a routine for waiting for the user to enter the choice narrow-down conditions, and then waits for an entry of the choice narrow-down conditions.

In Step S1117, the CPU 206 of the client apparatus 104 transmits the choice narrow-down conditions entered by the user in Step S1115 to the server apparatus 101 via the network I/F 211, to thereby notify the server apparatus 101 of the choice narrow-down request to choose and narrow down the authentication image data.

The processing described above enables the CPU 206 of the client apparatus 104 to make the authentication request only by transmitting to the server apparatus 101 the authentication image data selected by the user from among the plurality of image data received from the server apparatus 101 and the password corresponding to the authentication image data. Further, by setting the choice narrow-down conditions, the user of the client apparatus 104 can easily select desired authentication image data from among a plurality of authentication image data received by the client apparatus 104 from the server apparatus 101.

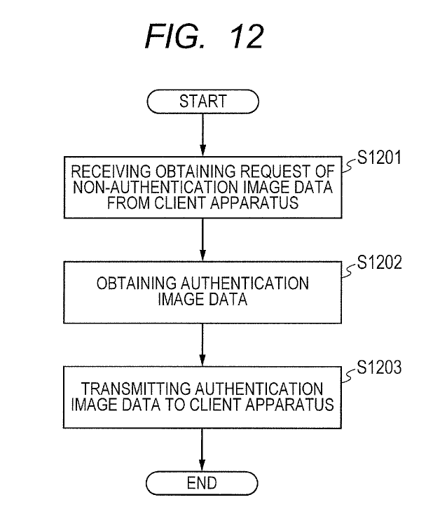

FIG. 12 is a flow chart illustrating an example of processing executed when the server apparatus 101 receives the request to obtain the non-authentication image data from the client apparatus 104.

In Step S1201, the CPU 206 of the server apparatus 101 receives the request to obtain the non-authentication image data from the client apparatus 104 via the network I/F 211. Note that, the processing of Step S1201 is an example of obtaining request reception processing.

In Step S1202, the CPU 206 of the server apparatus 101 obtains from the HDD 209 the authentication image data usable for authentication and the image data unusable for authentication as candidate images for the authentication image data.

In Step S1203, the CPU 206 of the server apparatus 101 transmits the candidate images for the authentication image data obtained in Step S1202 to the client apparatus 104 via the network I/F 211. This processing is an example of request transmission processing in which the CPU 206 of the server apparatus 101 transmits the request for the password associated with the authentication image data together with the transmitted authentication image data.

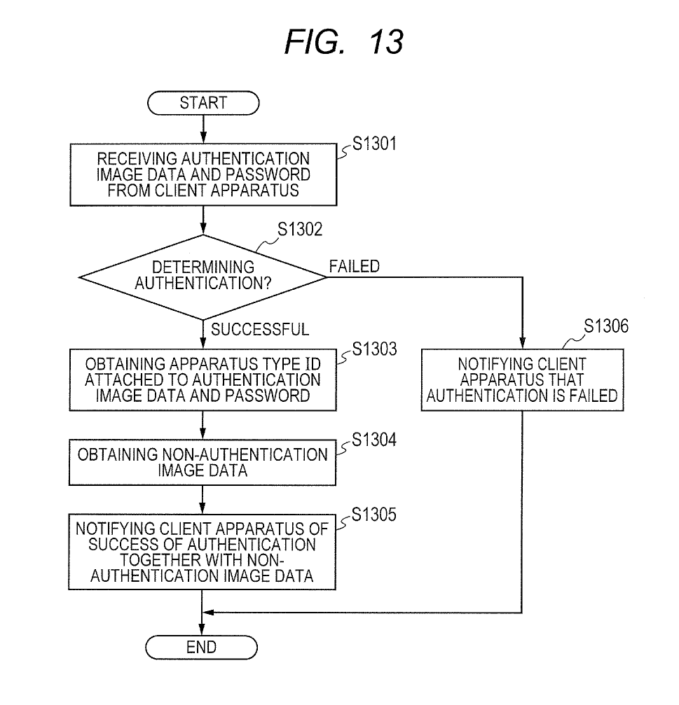

FIG. 13 is a flow chart illustrating an example of processing executed in a case where the server apparatus 101 receives the authentication request from the client apparatus 104.

In Step S1301, the CPU 206 of the server apparatus 101 receives the authentication image data and the password from the client apparatus 104 via the network I/F 211.

In Step S1302, the CPU 206 of the server apparatus 101 determines whether or not user authentication is successful based on the authentication image data and password received in Step S1301. To be more specific, the CPU 206 of the server apparatus 101 compares the combination of the received authentication image data and the password with the combination of the authentication image data and the password held in the HDD 209 to determine whether or not there is a matching combination. Then, in a case where there is a matching combination, the CPU 206 of the server apparatus 101 determines that the authentication is successful, and proceeds the processing to Step S1303. On the other hand, in a case where there is no matching combination, the CPU 206 of the server apparatus 101 determines that the authentication is failed, and proceeds the processing to Step S1306.

In Step S1303, the CPU 206 of the server apparatus 101 obtains from the HDD 209 an apparatus type ID attached to the matching combination of the authentication image data and the password.

In Step S1304, the CPU 206 of the server apparatus 101 obtains from the HDD 209 the non-authentication image data associated with the apparatus type ID obtained in Step S1303.

In Step S1305, the CPU 206 of the server apparatus 101 notifies via the network I/F 211 the client apparatus 104 of success of authentication together with the non-authentication image data obtained in Step S1304.

In Step S1306, the CPU 206 of the server apparatus 101 notifies via the network I/F 211 the client apparatus 104 that the authentication is failed.

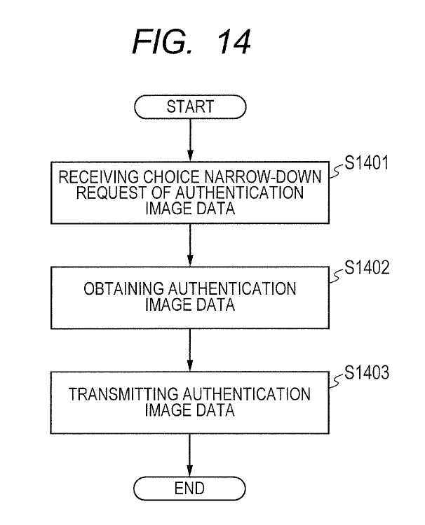

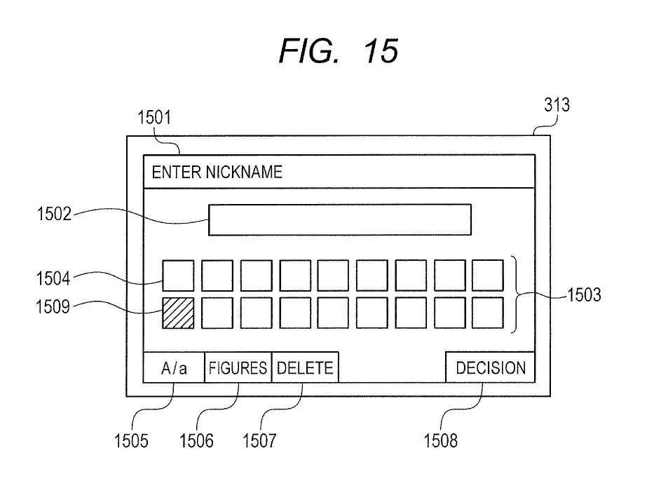

FIG. 14 is a flow chart illustrating an example of processing executed when the server apparatus 101 receives from the client apparatus 104 the choice narrow-down request to choose and narrow down the authentication image data.

In Step S1401, the CPU 206 of the server apparatus 101 receives the choice narrow-down request including the choice narrow-down conditions from the client apparatus 104 via the network I/F 211. Note that, the choice narrow-down conditions received by the CPU 206 of the server apparatus 101 in this step are data indicating the type of the apparatus, the photographing date and time, and the like, which correspond to the meta data included in the authentication image data picked up by the imaging apparatus 102.

In Step S1402, the CPU 206 of the server apparatus 101 obtains from the HDD 209 the authentication image data satisfying the received combination of the choice narrow-down conditions.

In Step S1403, the CPU 206 of the server apparatus 101 transmits the authentication image data obtained in Step S1402 to the client apparatus 104 via the network I/F 211.

As described above, the data management system according to this embodiment enables the user to easily register the combination of the authentication image data picked up by the imaging apparatus 102 and the password entered by the user as the authentication information. In addition, the data management system according to this embodiment can ensure security against a wrong usage of a service by setting the combination of the authentication image data and the password as the authentication information. Moreover, in the data management system according to this embodiment, the client apparatus 104 does not need to hold the authentication image data. This means that an electronic apparatus to be used by the user to make a request to obtain the non-authentication image data from the server apparatus 101 does not need to hold the authentication image data. In short, the user can make use of the service of the data management system according to this embodiment with use of various electronic apparatus.

### Second Embodiment

In the first embodiment described above, in a case where there are a large number of candidates for the authentication image data having similar meta data, even if the user chooses and narrows down the candidates for the authentication image data usable for authentication, a large number of image data are displayed in the authentication image data selection screen as a result. In other words, the user cannot easily select the authentication image data in some cases even after choosing and narrowing down the candidates. In view of this, in a second embodiment of the present invention, a description is given of processing for enabling the user to easily select the authentication image data even in the case where there are a large number of candidates for the authentication image data having similar meta data. Note that, a description of components and configurations similar to those of the first embodiment is omitted in the following.

FIG. 15 is a diagram illustrating an example of a nickname input screen displayed on the liquid crystal monitor 313 of the imaging apparatus 102 in a case where the imaging apparatus 102 registers the authentication information in the server apparatus 101.

A message for prompting the user to enter the nickname is displayed in a nickname input screen 1501, which is displayed on the liquid crystal monitor 313.

A nickname entry field 1502 is an entry field for displaying the characters entered as the nickname.

Displayed in a character button display area 1503 are character buttons 1504 for alphabets and figures to be used at the time of entering the nickname.

An alphabet display switch button 1505 is a button for switching, when the character buttons 1504 for alphabets are displayed in the character button display area 1503, cases of the alphabets of the character buttons 1504 to be displayed in the character button display area 1503 between the lower-case alphabets and the upper-case alphabets. In addition, the alphabet display switch button 1505 is a button for switching, when the character buttons 1504 for figures are displayed in the character button display area 1503, the character buttons to be displayed in the character button display area 1503 to the buttons for alphabets.

A figure display switch button 1506 is a button for switching, when the character buttons 1504 for alphabets are displayed in the character button display area 1503, the character buttons to be displayed in the character button display area 1503 to the buttons for figures.

An input character deletion button 1507 is a button for deleting the last character of the nickname currently entered. When the user selects the input character deletion button 1507 to delete the last character of the nickname currently entered, the last character of the characters displayed in the nickname entry field 1502 is no longer displayed.

A nickname decision button 1508 is a button for deciding the characters displayed in the nickname entry field 1502 as the nickname.

The user operates the character buttons 1504, the alphabet display switch button 1505, the figure display switch button 1506, the input character deletion button 1507, and the nickname decision button 1508 with use of the cursor button 404 and the set button 405. To be more specific, the user operates the cursor button 404 in the upward or downward direction to move a cursor 1509 indicating that a corresponding item is currently selected, and then depresses the set button 405. Note that, the screen configuration may be such that, in a case where there is no character displayed in the nickname entry field 1502, the nickname decision button 1508 is grayed out so that even if the user operates the cursor button 404, the user cannot select the nickname decision button 1508.

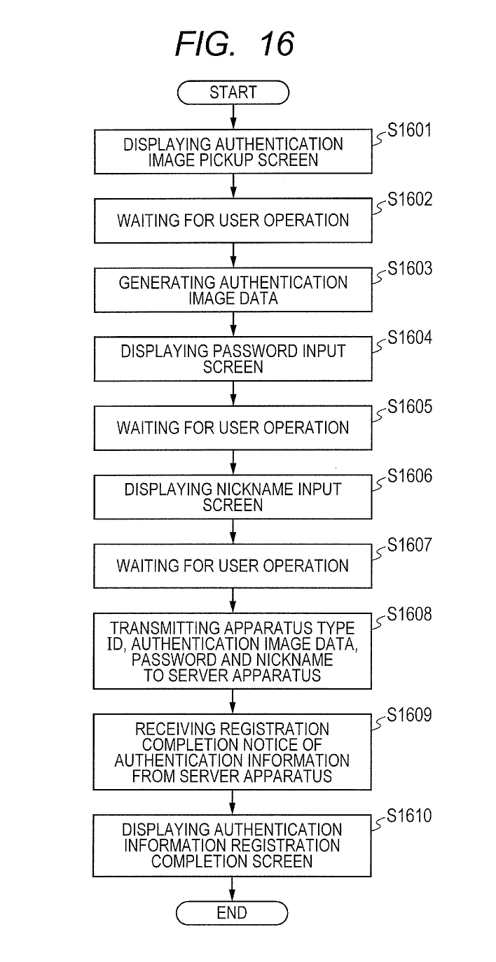

FIG. 16 is a flow chart illustrating an example of processing executed in a case where the imaging apparatus 102 registers the authentication information in the server apparatus 101.

The processing of Step S1601 to Step S1605 is similar to the processing of Step S601 to Step S605 illustrated in FIG. 6, and hence a description thereof is omitted. In addition, the processing of Step S1609 and Step S1610 is similar to the processing of Step S607 and Step S608 illustrated in FIG. 6, and hence a description thereof is omitted.

In Step S1606, the system control unit 307 displays the nickname input screen 1501 on the liquid crystal monitor 313.

In Step S1607, the system control unit 307 is now in a routine for waiting for the user to enter the nickname, and then waits for an entry of the nickname.

In Step S1608, the system control unit 307 transmits to the server apparatus 101 the apparatus type ID, the authentication image data generated in Step S1603, the password entered in Step S1605, and data on the nickname (hereinafter simply referred to as “nickname”) entered in Step S1607. In this manner, the system control unit 307 notifies the server apparatus 101 of a request to register the authentication information. Note that, the apparatus ID as the imaging apparatus identifier is held in advance in the ROM 308 of the imaging apparatus 102.

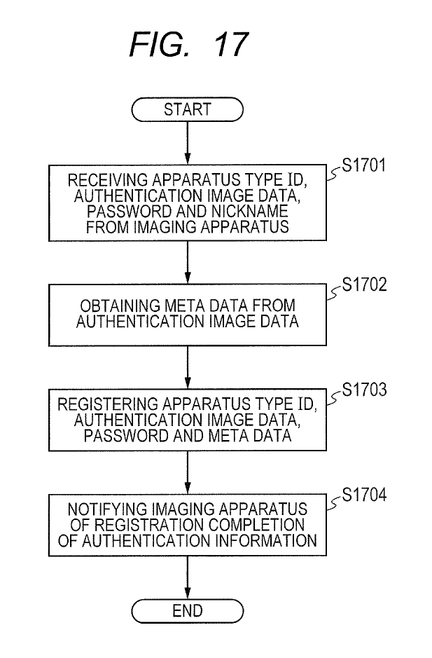

FIG. 17 is a flow chart illustrating an example of processing executed in a case where the server apparatus 101 receives the request to register the authentication information from the imaging apparatus 102.

The processing of Step S1702 and Step S1704 is similar to the processing of Step S702 and Step S704 illustrated in FIG. 7, and hence a description thereof is omitted.

In Step S1701, the CPU 206 of the server apparatus 101 receives the apparatus type ID, the authentication image data, the password, and the nickname from the imaging apparatus 102 via the network I/F 211.

In Step S1703, the CPU 206 of the server apparatus 101 holds the apparatus type ID, authentication image data, password, and nickname received in Step S1701 and the meta data obtained in Step S1702 in the HDD 209 of the server apparatus 101 to register those information and data.

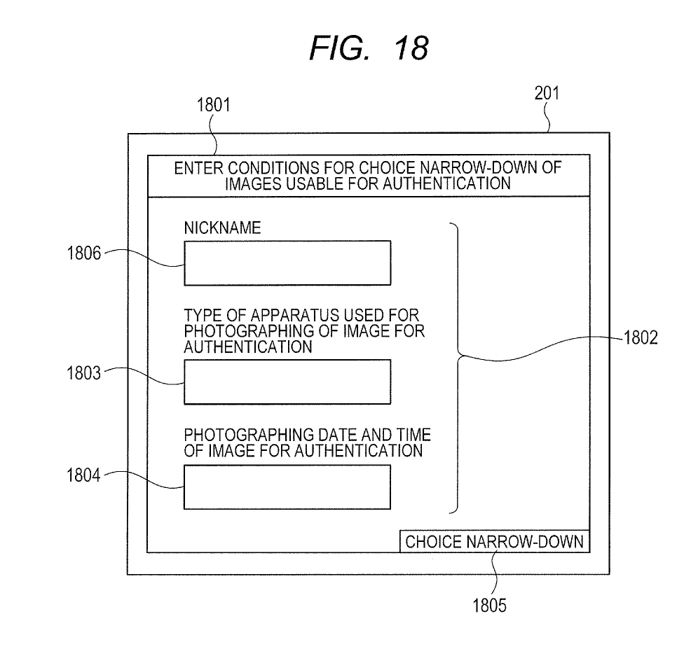

FIG. 18 is a diagram illustrating another example of the choice narrow-down condition setting screen.

Displayed in a choice narrow-down condition setting screen 1801, which is displayed on the display 201, is a message for prompting the user to enter conditions for choice narrow-down of the authentication image data 1003 to be displayed in the authentication image data selection screen 1001.

Displayed in a choice narrow-down condition display area 1802 is a nickname entry field 1806 for entering the nickname, which is usable as a condition for choosing and narrowing down the authentication image data 1003. Also displayed in the choice narrow-down condition display area 1802 are an apparatus type entry field 1803 for entering the type of the apparatus that picked up the authentication image data and a photographing date and time entry field 1804 for entering the photographing date and time.

The nickname entry field 1806 is an entry field for displaying the characters entered as the nickname.

The apparatus type entry field 1803 is an entry field for displaying the characters entered as the type of the apparatus that picked up the authentication image data.

The photographing date and time entry field 1804 is an entry field for displaying the characters entered as the photographing date and time at which the authentication image data was picked up.

A choice narrow-down button 1805 is a button for determining the characters displayed in the nickname entry field 1806, the apparatus type entry field 1803, and the photographing date and time entry field 1804 as the choice narrow-down conditions. The choice narrow-down button 1805 is also a button for sending the choice narrow-down request to choose and narrow down the image data to the server apparatus 101. If the user operates the PD 205 to depress the choice narrow-down button 1805, the client apparatus 104 transmits the determined choice narrow-down conditions to the server apparatus 101. This configuration enables the user of the client apparatus 104 to easily select desired authentication image data even in a case where a large number of image data are displayed, thus enhancing the convenience. Note that, it is not always necessary that the choice narrow-down conditions include all of the nickname, the type of the apparatus, and the photographing date and time. The choice narrow-down conditions may include any one of those conditions, or may include a combination selected arbitrarily from among those conditions. In addition, the screen configuration may be such that, in a case where there is no character displayed in any of the nickname entry field 1806, the apparatus type entry field 1803, and the photographing date and time entry field 1804, the choice narrow-down button 1805 is grayed out so that even if the user operates the PD 205, the user cannot depress the choice narrow-down button 1805.

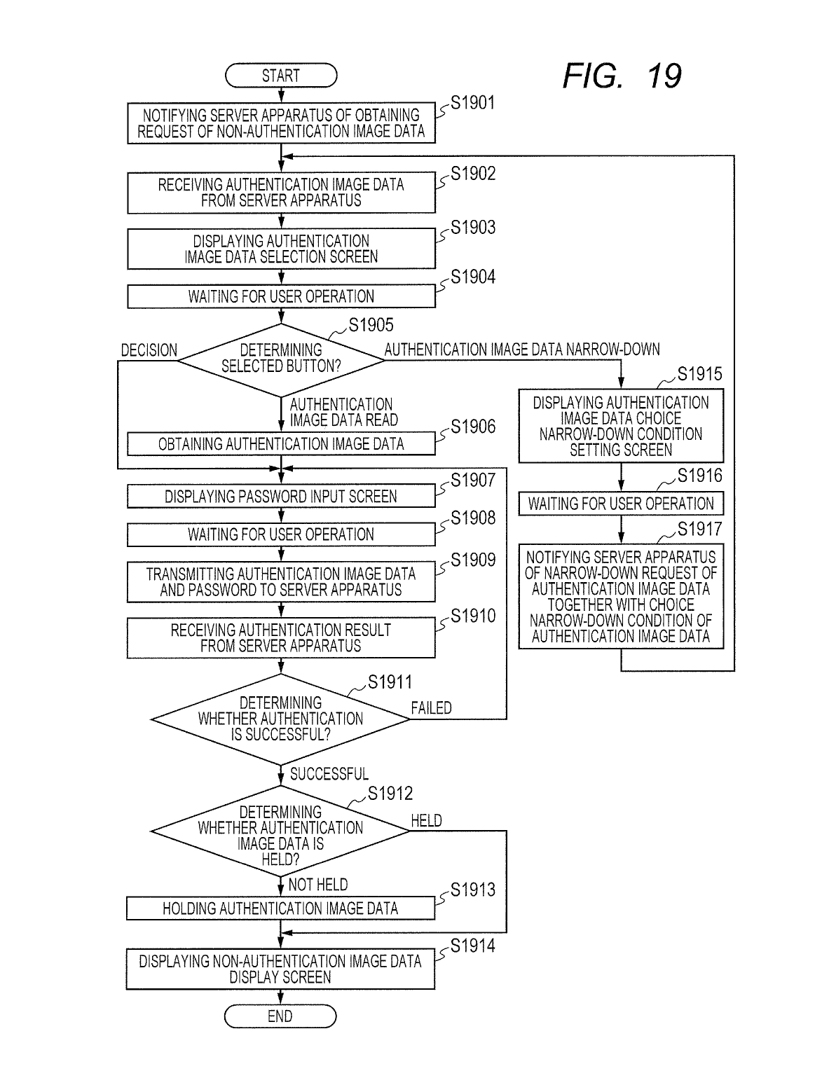

FIG. 19 is a flow chart illustrating an example of processing executed in a case where the client apparatus 104 obtains the non-authentication image data from the server apparatus 101.

The processing of Step S1901 to Step S1914 is similar to the processing of Step S1101 to Step S1114 illustrated in FIG. 11, and hence a description thereof is omitted. In addition, the processing of Step S1916 is similar to the processing of Step S1116 illustrated in FIG. 11, and hence a description thereof is omitted.

In Step S1915, the CPU 206 of the client apparatus 104 displays the authentication choice narrow-down condition setting screen 1801 on the display 201.

In Step S1917, the CPU 206 of the client apparatus 104 transmits the choice narrow-down conditions entered by the user in Step S1915 to the server apparatus 101 via the network I/F 211, to thereby notify the server apparatus 101 of the choice narrow-down request to choose and narrow down the authentication image data.

The processing described above enables the user of the client apparatus 104 to easily select desired authentication image data from among a plurality of image data received by the client apparatus 104 from the server apparatus 101 by setting the choice narrow-down conditions. In particular, in the case where there are a large number of authentication image data having similar meta data, the user of the client apparatus 104 can easily select desired authentication image data from among the plurality of image data by entering the nickname so that the entered nickname is included as the choice narrow-down condition.

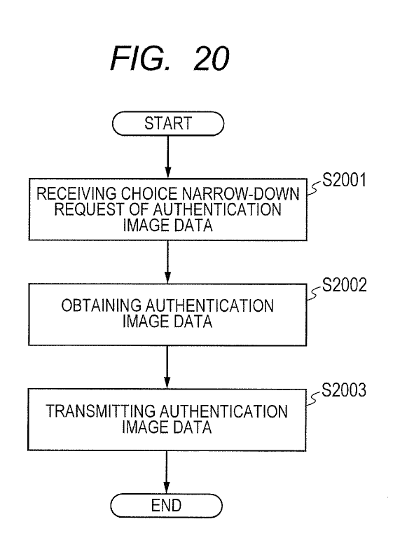

FIG. 20 is a flow chart illustrating an example of processing executed in a case where the server apparatus 101 receives the request to choose and narrow down the authentication image data from the client apparatus 104.

In Step S2001, the CPU 206 of the server apparatus 101 receives the choice narrow-down conditions from the client apparatus 104 via the network I/F 211. Note that, the choice narrow-down conditions received in this step are the data indicating the type of the apparatus, the photographing date and time, and the like, which correspond to the meta data included in the authentication image data picked up by the imaging apparatus 102, and the nickname.

In Step S2002, the CPU 206 of the server apparatus 101 obtains from the HDD 209 the authentication image data satisfying the received combination of the choice narrow-down conditions.

In Step S2003, the CPU 206 of the server apparatus 101 transmits the authentication image data obtained in Step S2002 to the client apparatus 104 via the network I/F 211.

The processing described above enables the user of the client apparatus 104 to easily select the authentication image data.

As described above, in the data management system according to this embodiment, the client apparatus 104 transmits to the server apparatus 101 the choice narrow-down request to choose and narrow down the authentication image data with use of the choice narrow-down conditions including the nickname. This configuration enables the user of the client apparatus 104 to easily select desired authentication image data even in the case where there are a large number of candidates for the authentication image data having similar meta data.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-120529, filed Jun. 7, 2013, which is hereby incorporated by reference herein in its entirety.

What is claimed is:

1. A server apparatus, comprising:
a first management unit configured to relate authentication image data of user authentication to authentication input data and manage the related data as authentication information;
a request transmission unit configured to transmit a plurality of image data including the authentication image data included in the authentication information managed by the first management unit and transmit a request for the authentication input data related to the authentication image data;
a reception unit configured to receive image data selected by a user from among the plurality of image data and input data input by the user in accordance with the request transmitted by the request transmission unit; and
a determination unit configured to determine whether or not the user is successfully authenticated based on whether or not the authentication information in which the image data and the input data that are received by the reception unit are related to each other is managed by the first management unit.

2. A server apparatus according to claim 1, further comprising an obtaining request reception unit configured to receive a request to obtain non-authentication image data, which is unused for user authentication, from an information processing apparatus capable of establishing communication to/from the server apparatus,
wherein the request transmission unit is further configured to transmit, in response to the obtaining request received by the obtaining request reception unit, the plurality of image data including the authentication image data and transmit the request for the authentication input data related to the authentication image data.

3. A server apparatus according to claim 2, wherein:
the obtaining request reception unit is further configured to receive, from the information processing apparatus, a choice narrow-down request to choose and narrow down a plurality of image data to be transmitted by the request transmission unit together with the obtaining request; and
the request transmission unit is further configured to transmit, in response to the obtaining request, a plurality of image data satisfying a choice narrow-down condition included in the choice narrow-down request.

4. A server apparatus according to claim 3, wherein the choice narrow-down condition comprises at least one of:
a type of an apparatus which picks up the authentication image data;
a date and time at which the authentication image data is picked up; or
a nickname which is set by the user.

5. A server apparatus according to claim 2, further comprising a transmission unit configured to transmit, in a case where the determination unit determines that the user is successfully authenticated, the non-authentication image data associated with the obtaining request to the information processing apparatus.

6. A server apparatus according to claim 5, wherein:
the first management unit is further configured to relate authentication information in which authentication image data received from an imaging apparatus capable of establishing communication to/from the server apparatus and the authentication input data are related to each other to identification data for identifying the imaging apparatus which is received from the imaging apparatus, and manage the related authentication information and identification data as first relation data;
the server apparatus further comprises a second management unit configured to relate non-authentication image data received from the imaging apparatus to the identification data, and manage the related non-authentication image data and identification data as second relation data; and
the transmission unit is further configured to obtain, from the first relation data managed by the first management unit, the identification data related to the authentication information used for the determination of the user authentication, obtain the non-authentication image data from the second relation data managed by the second management unit based on the obtained identification data, and transmit the obtained non-authentication image data to the information processing apparatus.

7. An imaging apparatus, comprising:
a generation unit configured to pick up a subject and generate image data;
a reception unit configured to receive input data input by a user via an operation screen;
a first transmission unit configured to transmit one of image data generated by the generation unit to an external apparatus as authentication image data by relating the one of image data to first input data received by the reception unit and identification data for identifying the own imaging apparatus; and
a second transmission unit configured to transmit other image data than the authentication image data among the image data generated by the generation unit to the external apparatus as non-authentication image data by relating the other image data to the identification data,
wherein the external apparatus is configured to transmit a plurality of image data including the authentication image data to a communication apparatus, obtain a piece of image data selected from among the plurality of image data that are transmitted and an identification code related to second input data input to the communication apparatus, and transmit the non-authentication image data related to the obtained identification code to the communication apparatus.

8. An imaging apparatus according to claim 7, wherein the first transmission unit is further configured to transmit a nickname relating to an input of a character string received by the reception unit by relating the nickname to the first relation data.

9. An imaging apparatus according to claim 7, further comprising a switching unit configured to switch operation screens between a first operation screen to be used to pick up the authentication image data and a second operation screen to be used to pick up the non-authentication image data,
wherein the generation unit is configured to pick up the authentication image data with use of the first operation screen and pick up the non-authentication image data with use of the second operation screen.

10. An information processing method executed by a server apparatus, comprising:
relating authentication image data of user authentication to authentication input data and managing the related data as authentication information;
transmitting a plurality of image data including the authentication image data included in the managed authentication information and transmitting a request for the authentication input data related to the authentication image data;
receiving image data selected by a user from among the plurality of image data and input data input by the user in accordance with the transmitted request; and
determining whether or not the user is successfully authenticated based on whether or not the authentication information in which the image data and the input data that are received in the receiving are related to each other is managed.

11. An information processing method executed by an imaging apparatus, comprising:
picking up a subject and generating image data;
receiving input data input by a user via an operation screen;
transmitting one the generated image data to an external apparatus as authentication image data by relating the one piece of image data to the received first input data and identification data for identifying the own imaging apparatus; and
transmitting other image data than the authentication image data among the generated image data to the external apparatus as non-authentication image data by relating the other image data to the identification data,
wherein the external apparatus is configured to transmit a plurality of image data including the authentication image data to a communication apparatus, obtain image data selected from among the plurality of image data that are transmitted and an identification code related to second input data input to the communication apparatus, and transmit the non-authentication image data related to the obtained identification code to the communication apparatus.

12. A non-transitory computer-readable storage medium storing a program for causing a computer to execute the information processing method according to claim 10.

13. A non-transitory computer-readable storage medium storing a program for causing a computer to execute the information processing method according to claim 11.
